(19) United States
(12) Patent Application Publication
(10) Pub. No.: US 2023/0258314 A1
(43) Pub. Date: Aug. 17, 2023

(54) Microlens Array, Diffuser Plate, and Illumination Apparatus

(71) Applicant: Daicel Corporation, Osaka (JP)

(72) Inventors: Makoto Yasuhara, Tokyo (JP); Maki Kishimoto, Tokyo (JP)

(73) Assignee: Daicel Corporation, Osaka (JP)

(21) Appl. No.: 18/110,984

(22) Filed: Feb. 17, 2023

(30) Foreign Application Priority Data
Feb. 17, 2022 (JP) 2022-023094

(51) Int. Cl. F21V 5/00; F21V 3/04

(52) U.S. Cl. CPC F21V 5/007; F21V 3/049

(57) ABSTRACT

A technique with which a more uniform irradiance distribution can be more easily obtained than before is provided. A microlens array includes a plurality of lens elements arrayed on at least one surface of a planar member. A pitch D between the lens elements in the microlens array randomly varies in a range of ±ΔD, and the ΔD satisfies

0≤ΔD≤λ/(n1×sin β),
where λ represents a wavelength of incident light, n1 represents a refractive index in air, and β represents an emission angle of light that has passed through the microlens array.

### TECHNICAL FIELD

The present invention relates to a microlens array, a diffuser plate, and an illumination apparatus.

### BACKGROUND ART

For example, a known microlens array has a plurality of lens elements arrayed and is used for an apparatus for illumination, measurement, facial recognition, spatial recognition, and the like (see for example, Patent Document 1). When such a microlens array is used for the purpose of optically making light from a light source uniform, and if a pitch between the lens elements is too small, interference fringes due to interference of light transmitted between the lens element becomes obvious and may hinder the uniformity of light-source light. On the other hand, when the pitch between the lens elements is too large, the light irradiated from the light source is non-uniformly incident on the microlens array, which cause moire fringes and may result in non-uniform irradiation distribution. As a result, when a screen or the like is irradiated with the light-source light using the microlens array, irradiance distribution may be non-uniform. FIG. 15A illustrates an example of an irradiance distribution without interference fringes or moire fringes. FIG. 15B illustrates an irradiance distribution in a case where interference fringes are produced. FIG. 15C illustrates an irradiance distribution in a case where moire fringes are produced.

To suppress the above-described non-uniformity of the irradiance distribution due to the interference fringes, a measure is devised that the positions, the shapes, and the like of the lens elements distributed are randomized (for example, see Patent Document 2). Unfortunately, excessive randomization may not provide desired light distribution characteristics, and in particular, may make it difficult to sharpen an edge of an irradiation profile. Furthermore, a complicated array of the lens elements may cause disadvantages such as a long production time and a high production cost.

### CITATION LIST

### Patent Document

Patent Document 1: WO 2005/103795
Patent Document 2: WO 2015/182619

### SUMMARY OF INVENTION

### Technical Problem

The technique of the present disclosure is invented in view of the above, and an object thereof is to provide a technique with which a more uniform irradiance distribution can be more easily obtained than before using a microlens array.

### Solution to Problem

To solve the problem described above, a microlens array according to the present disclosure includes a plurality of lens elements arrayed on at least one surface of a planar member, wherein a pitch D between the lens elements in the microlens array randomly varies in a range of ±ΔD, and the ΔD satisfies 0≤ΔD≤λ(n1×sin β), where represents a wavelength of incident light, n2 represents a refractive index of the microlens array, and β represents an emission angle (an angle with respect to an optical axis) of light that has passed through the microlens array.

With this configuration, the difference ΔK in the wavenumber K based on an optical path difference of light incident on the lens elements of the microlens array can be randomly changed in a range of 0 to 1. Thus, with the resultant irradiance distribution of the light that has passed through the microlens array, interference fringes can be prevented from being noticeable. Note that when a is defined as a propagation angle (angle with respect to the optical axis) of the incident light in the microlens array, n2×sin α=n1×sin β holds based on the Snell's law, and thus, the above formula can be converted into

0≤ΔD≤λ/(n2×sin α).

The microlens array includes a plurality of lens elements arrayed on at least one surface of a planar member, wherein the pitch D between the lens elements in the microlens array randomly varies in a range of ±ΔD, and

the ΔD may satisfy

0≤ΔD/D≤22%.

The microlens array includes a plurality of lens elements arrayed on at least one surface of a planar member, wherein

the pitch D between the lens elements in the microlens array randomly varies in a range of ±ΔD, and a height H of the lens elements varies in a range of ΔH, and

the ΔD and the ΔH satisfy

$$[ Math . 1 ]$$

$$o ≦ n 1 \times Δ D \cdot sin β + Δ H ( \frac{n 2}{\sqrt{1 - {( \frac{n 1}{n 2} \cdot sin β )}^{2}}} - \frac{n 1}{cos θ} ) ≦ λ ,$$

where θ represents an angle of light incident on each of the lens elements of the microlens array with respect to an optical axis.

Also with these configurations, the difference ΔK in the wavenumber K based on an optical path difference of light incident on the lens elements of the microlens array can be randomly changed in a range of 0 to 1. Thus, with the resultant irradiance distribution of the light that has passed through the microlens array, interference fringes can be prevented from being noticeable. Note that when a is defined as a propagation angle (angle with respect to the optical axis) of the incident light in the microlens array, n2×sin α=n1×sin β holds based on the Snell's law, and thus, the above formula can be converted into

$$[ Math . 2 ]$$

$$o ≦ n 2 \times Δ D \cdot sin α + Δ H ( \frac{n 2}{cos α} - \frac{n 1}{cos θ} ) ≦ λ ,$$

The planar member and the lens elements in the microlens array may be formed integrally by the same material, or may be formed by different materials.

A diffuser plate may be formed using the microlens array described above.

An illumination apparatus may be formed by the microlens array described above and a light source that emits light incident on the microlens array. In such a case, a holder for holding the microlens array may be further used.

In the illumination apparatus described above, the lens elements of the microlens array may be arrayed on a surface on a side close to the light source.

The light source may be a laser light source that emits near-infrared light.

The illumination apparatus described above may be used in distance measuring equipment using a Time Of Flight system.

Note that, in the present invention, wherever possible, the techniques for solving the above-described problem can be used in combination.

### Advantageous Effects of Invention

According to the present disclosure, a more uniform irradiance distribution can be more easily obtained than before using a microlens array.

### BRIEF DESCRIPTION OF DRAWING

FIG. 1 is a diagram illustrating a schematic configuration of distance measuring equipment using a Time Of Flight system.

FIG. 2 is a diagram illustrating an evaluation system in which a screen is irradiated with light emitted from a light source and transmitted through a microlens array.

FIG. 3 is an enlarged view illustrating a cross section of the microlens array and an enlarged optical path of incident light.

FIG. 4 illustrates an example of interference fringes observed on the screen for the light that has passed through the microlens array.

FIG. 5 is a graph illustrating a relationship between an emission angle and wavenumber (phase difference).

FIG. 6A, 6B are graphs illustrating a relationship between the incident light phase difference and the intensity on the screen.

FIG. 7 is a graph illustrating a relationship between an emission light angle β (deg) and a change ΔD (μm) in pitch, with various ΔK.

FIG. 8 is a graph illustrating a relationship between a pitch D and a pitch change rate ΔD/D with values of ΔK.

FIG. 9 is a second graph illustrating the relationship between the pitch D and the pitch change rate ΔD/D with values of ΔK.

FIG. 10 is a graph illustrating a predicted value of light intensity on a screen in a case where the number N of superimposed light beams is 10.

FIG. 11 is a graph illustrating that the intensity of a peak portion of the light intensity on a screen is reduced by randomly arranging the optical path difference (phase difference) between light beams B with ΔK being in a range of 0 to 1.

FIG. 12 is an enlarged view illustrating a cross section of the microlens array and an optical path of incident light.

FIG. 13 is a perspective view of a diffuser plate obtained by forming the microlens array on a surface of a flexible sheet.

FIG. 14 is a diagram illustrating a schematic configuration of an illumination apparatus.

FIG. 15A-15C illustrate examples of the irradiance distribution of the light that has passed through the microlens array in a case where interference fringes and moiré fringes are not produced on a screen, and in a case where interference fringes and moiré fringes are produced on the screen.

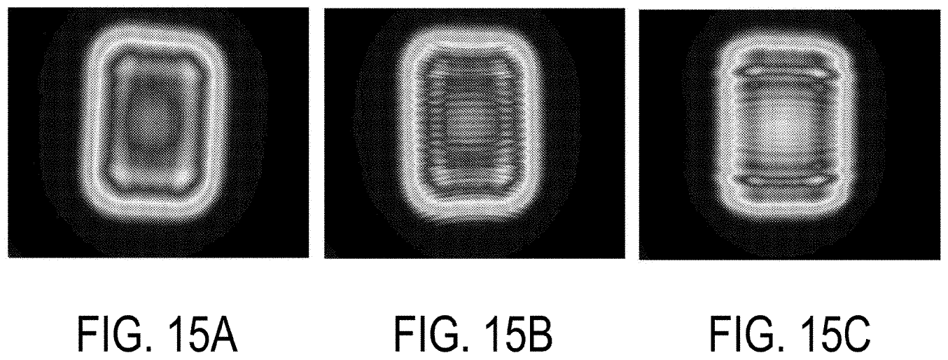

### DESCRIPTION OF EMBODIMENTS

A microlens array according to an embodiment of the present disclosure will be described below with reference to the drawings. Note that each of the configurations, combinations thereof, and the like in the embodiment are an example, and various additions, omissions, substitutions, and other changes may be made as appropriate without departing from the spirit of the present disclosure. The present disclosure is not limited by the embodiments and is limited only by the claims.

### First Embodiment

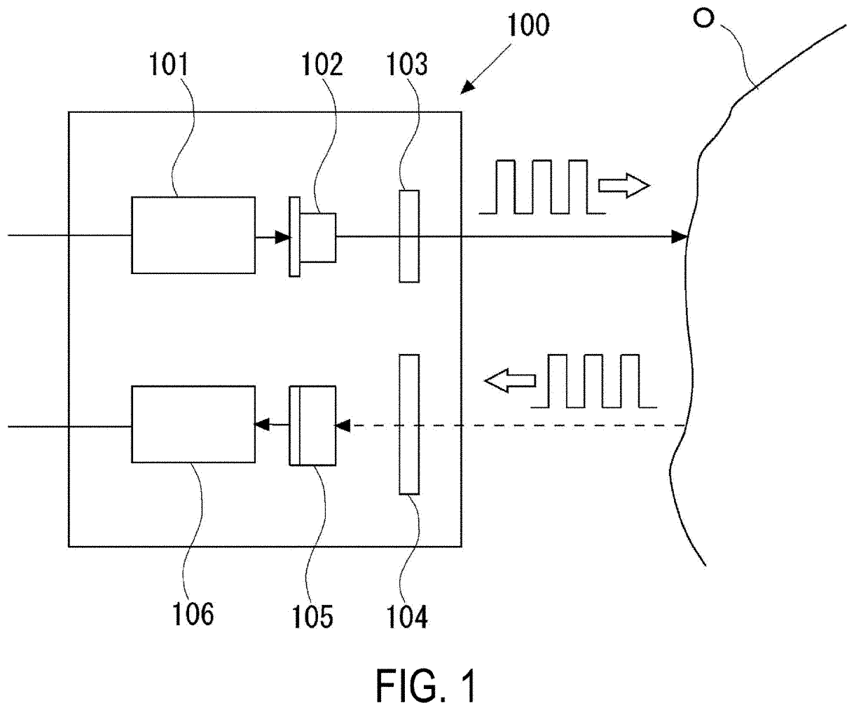

FIG. 1 is a schematic view illustrating distance measuring equipment 100 using a Time Of Flight (TOF) system, as an example of an application of a microlens array according to an embodiment. The distance measuring equipment 100 using the TOF system measures a distance to each part of a surface of a measurement target O by measuring time-of-flight of irradiation light, and includes a light source control unit 101, an irradiation light source 102, an irradiation optical system 103, a light receiving optical system 104 that collects reflected light from the measurement target O, a light receiving element 105, and a signal processing circuit 106.

When the irradiation light source 102 emits pulsed light based on a drive signal from the light source control unit 101, the pulsed light passes through the irradiation optical system 103 and is irradiated onto the measurement target O. The reflected light reflected on the surface of the measurement target O passes through the light receiving optical system 104, is received by the light receiving element 105, and then is converted into an appropriate electrical signal by the signal processing circuit 106. Then, a calculation unit (not illustrated) measures the distance to each location on the measurement target O by measuring the time from when the irradiation light is irradiated from the irradiation light source 102 until the light receiving element 105 receives the reflected light, that is, the time of flight of the light.

For the irradiation optical system 103 or the light receiving optical system 104 in the distance measuring equipment 100 using the TOF system, a microlens array may be used. The microlens array is a lens array formed by the group consisting of microlens elements having a diameter in a range of about 10 μm to several millimeters. The function and accuracy of the microlens array vary depending on the shape (such as spherical, aspherical, cylindrical, or hexagonal) of each lens element constituting the lens array, the size of the lens element, the arrangement of the lens elements, the pitch between the lens elements and the like.

When the microlens array is used for the distance measuring equipment 100 using the TOF system described above, the measurement target O is required to be irradiated with light with a uniform intensity distribution. That is, the angle of view θ_{FOI} (FOI: Field of Illumination) that is a usable divergence angle of light that has passed through the microlens array is determined according to the size of the measurement target O or the measurement distance, but in the range of the angle of view θ_{FOI}, the uniformity of the irradiance distribution of the light that has passed through the microlens array is required.

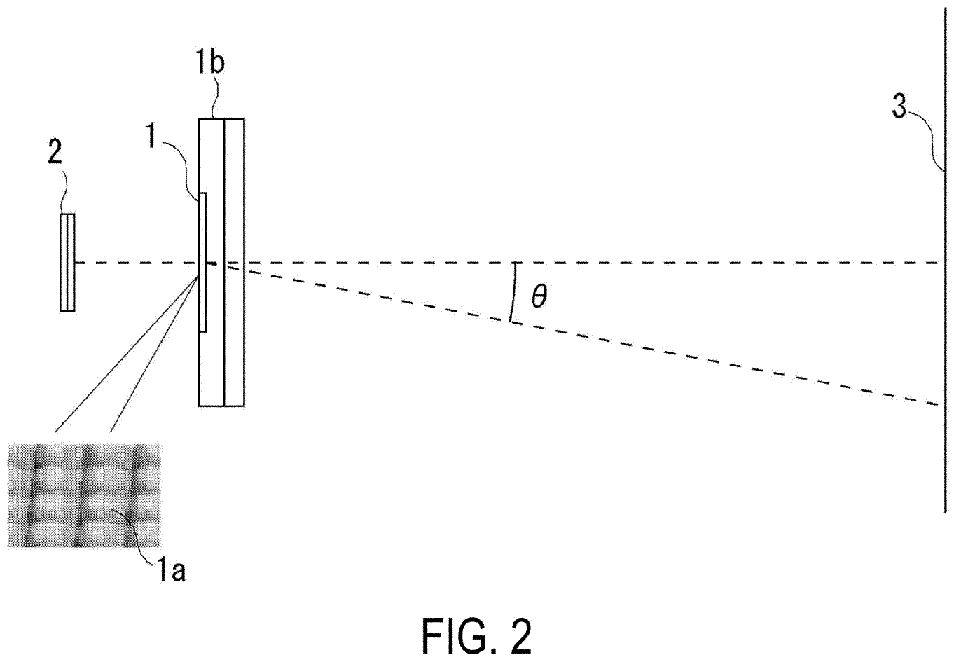

Next, a description will be given on an evaluation system in which a screen 3 is irradiated with light emitted from a light source 2 and passed through a microlens array 1 as illustrated in FIG. 2. Here, the light source 2 is, for example, a vertical cavity surface emitting laser (VCSEL) light source, and the directivity of the light source 2 can be selected from approximately ±5 degrees, ±10 degrees, and ±20 degrees, but is not particularly limited. The microlens array 1 formed by forming an array, in which lens elements 1a are two-dimensionally arrayed, is provided on one or both side surfaces of a substrate that is a planar member, and the light that has passed through the microlens array 1 turns into diffused light that diffuses with respect to an optical axis, and is irradiated onto the screen 3 simulating the measurement target O.

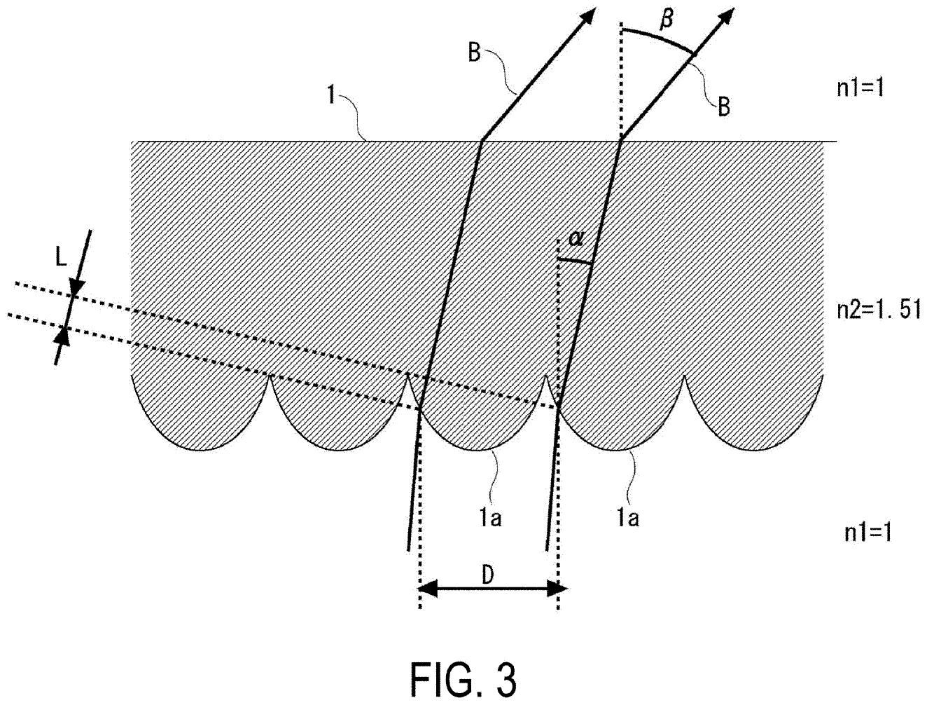

FIG. 3 is an enlarged cross-sectional view of the microlens array 1 having the lens elements 1a formed on the light source 2 side. As illustrated in FIG. 3, the microlens array 1 is basically characterized by a curved surface shape of each of the lens elements 1a and a distance (pitch) D between the lens elements 1a. As a material of the microlens array 1, a resin material or a glass material is used, but the material is not particularly limited. Here, a refractive index in air is defined as n1=1, and the refractive index of the material of the microlens array 1 is defined as n2=1.51.

As illustrated in FIG. 3, light incident at an angle with respect to the optical axis of the microlens array 1 is emitted from the microlens array 1 at a larger angle. Thus, as described above, the microlens array 1 can convert light from the light source 2 into diffused light diffused with respect to the optical axis. On the other hand, under a certain condition, interference fringes may be produced with the diffused light emitted from the microlens array 1. A description will be given below on two light beams B obliquely incident on the lens elements 1a adjacent to each other, to describe the occurrence of the interference fringes. The light beams B are assumed to be incident on the same locations of the lens elements 1a adjacent to each other. In this case, the two light beams B travel in the microlens array 1 in a direction inclined by an angle α (hereinafter, also referred to as a propagation angle α of the light beams B) with respect to a normal direction, in accordance with an angle of incidence on the lens elements 1a. Then, the light beams are further refracted at an emission surface that is a surface opposite to the incidence surface provided with the lens elements 1a, to travel in a direction inclined by an angle β with respect to the normal direction. In this case, Formula (1) below expresses optical path difference L as a result of the pitch D between the lens elements 1a, and wavenumber K based on the optical path difference L:

L=n2×D·sin α (1),

L/λ=K (2),

where λ represents the wavelength of incident light.

When the wavenumber K=N (integer) holds, the two light beams B are constructive, and when the wavenumber K=0.5+N holds, the two light beams B are destructive. Based on these relationships, the interference fringes are produced on the screen 3.

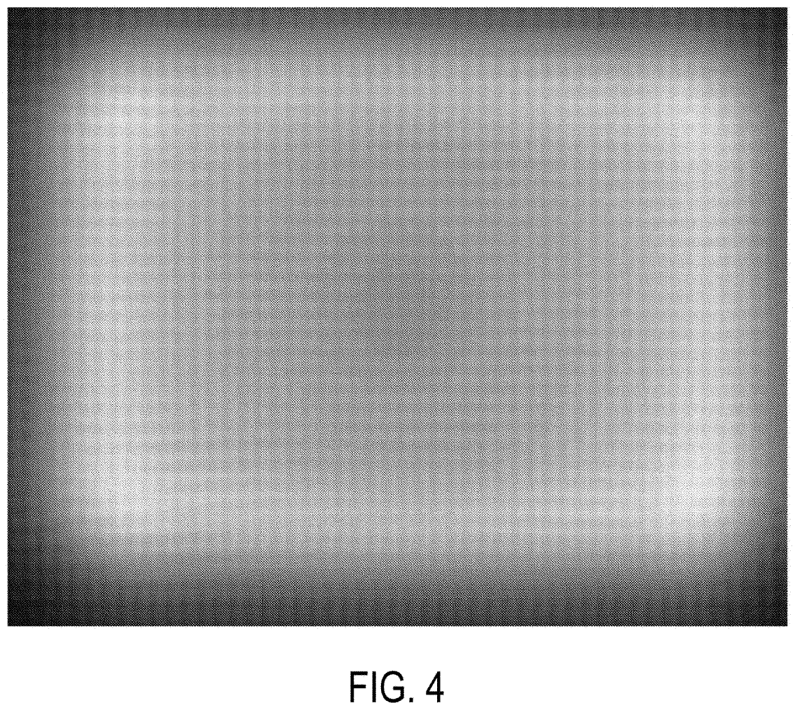

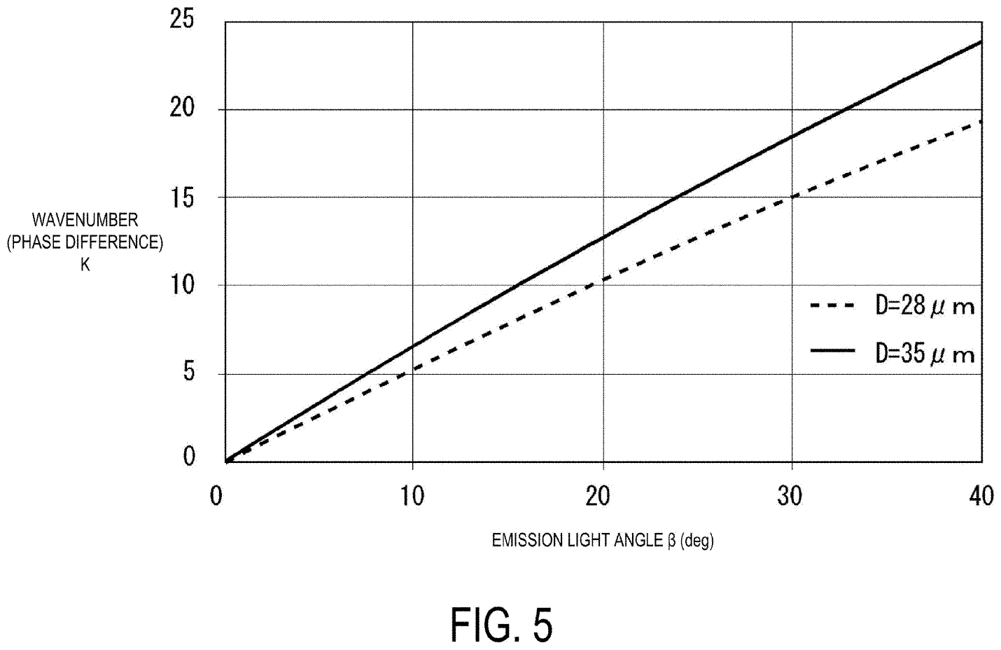

FIG. 4 illustrates an example of interference fringes observed on the screen 3 under the following conditions: the light has passed through the microlens array 1 with the angle of view θ_{FOI} of 52 deg; and the pitch D is 28 μm. FIG. 5 illustrates the relationship between the emission angle β and the wavenumber (phase difference) K. As illustrated in FIG. 5, the wavenumber K increases as the emission angle β increases. In the example of FIG. 4, the angle of view θ_{FOI} of the microlens array 1 is 52 deg (=2β), and thus the maximum value of the inclination angle β is expected to be 26 deg which is half the angle of view θ_{FOI}. According to the graph, the wavenumber (phase difference) K is 13 when the pitch D is 28, and thus about 13×2=26 fringes are expected to be observed with the angle of view of 52 deg. This number is consistent with the results seen in the photograph in FIG. 4. As illustrated in FIG. 5, it can be understood that the number of fringes is larger in a case where the pitch D is 28 μm, than in a case where the pitch D is 35 μm.

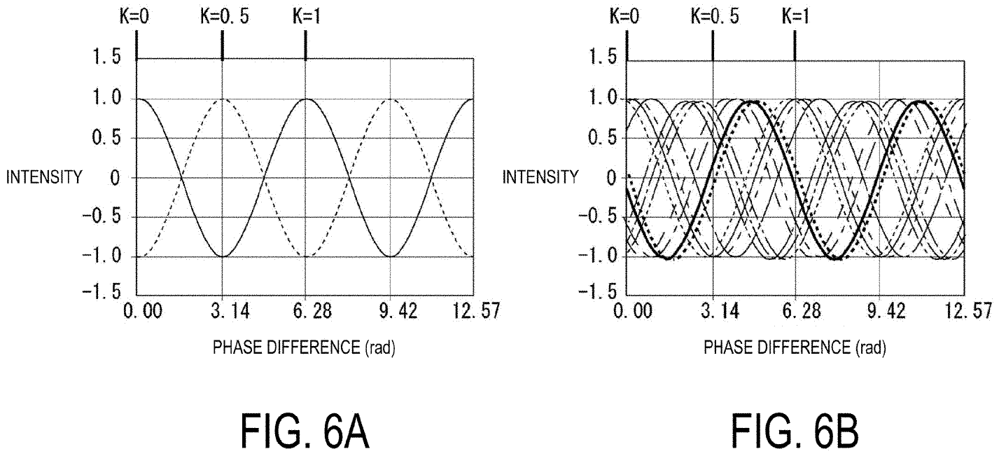

FIG. 6A illustrates an example of relationship between a phase difference between the two light beams B and light intensity obtained by the interference between the two light beams B in FIG. 3. FIG. 6A illustrates an example where a phase difference based on the optical path difference between the two light beams B is 3.14 rad (corresponding to wavenumber K=0.5). In this case, the two light beams B are constantly in the destructive relationship, meaning that dark lines of the fringes are observed at locations corresponding to the emission angle β on the screen 3.

On the other hand, as illustrated in FIG. 6B, by randomizing the phase difference within a range of values corresponding to the wavenumber K=0 to 1 for various combinations between the light beams B incident on the lens elements 1a in the microlens array 1, the light beams B corresponding to various phase differences overlap at the locations corresponding to the emission angle β on the screen 3. Thus, the intensity is averaged, whereby the interference fringes become less noticeable.

Here, when the pitch D is randomized, a change ΔL in the optical path difference L as a result of a change ΔD in the pitch D is as expressed in Formula (3) below:

ΔL=n2×ΔD·sin α (3).

A change ΔK in the wavenumber K is expressed by Formulae (4) and (5) below:

ΔL/λ=ΔK (4), and

(n2×ΔD·sin α)/λ=ΔK (5).

Based on these, Formula (6) below expresses the relationship between the maximum value of the change ΔK in the wavenumber K and the maximum value of the change ΔD in the pitch D:

ΔDmax=(ΔKmax×λ)/(n2×sin α) (6).

Under conditions that ΔKmax is 1, the propagation angle α of the light beams B in the microlens array 1 is 17 deg, and the wavelength of the light-source light is 0.94 μm, a maximum value ΔDmax of the change ΔD in the pitch D is obtained in Formula (7) below:

$$Δ D max = ( 1 \times 0.94 ) / ( 1.51 \times sin ( 17 deg ) ) \approx 2.13 μ m . \qquad ( 7 )$$

A ratio between the amounts of change with a reference value D of the pitch being 28 μm is obtained in Formula (8) below:

ΔDmax/D≈2.13/28=±3.8% (8).

As described below, with the pitch D randomly varying the wavenumber difference ΔK in the optical path difference between the two light beams B being 0 to 1, occurrence of the interference fringes is expected to be suppressed.

Thus, based on Formula (6), the occurrence of the interference fringes can be suppressed with ΔD randomly varied within a range of:

0≤ΔD≤λ/(n2×sin α) (9).

Note that, since n2×sin α=n1×sin β holds based on Snell's law, the formula described above can be converted into:

0≤ΔD≤λ/(n1×sin β) (9B).

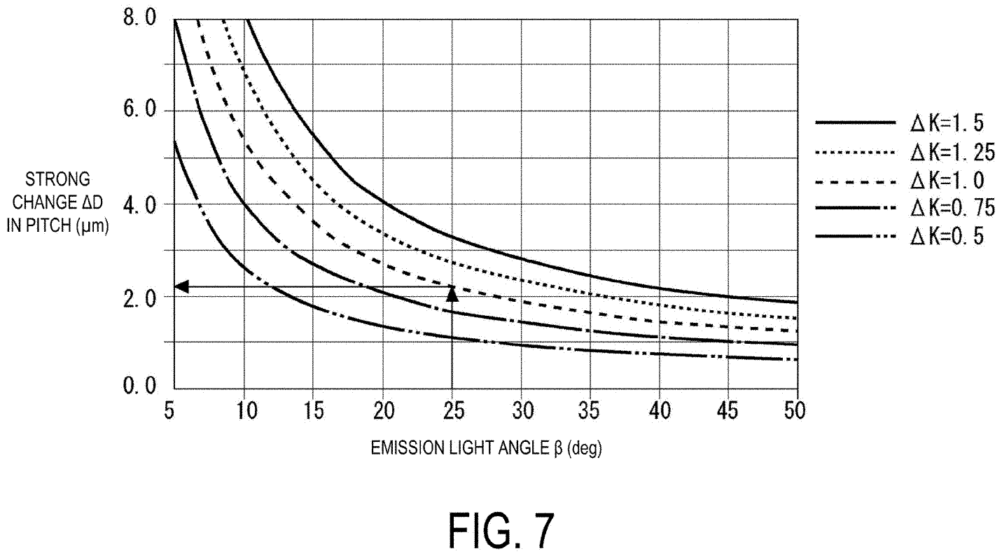

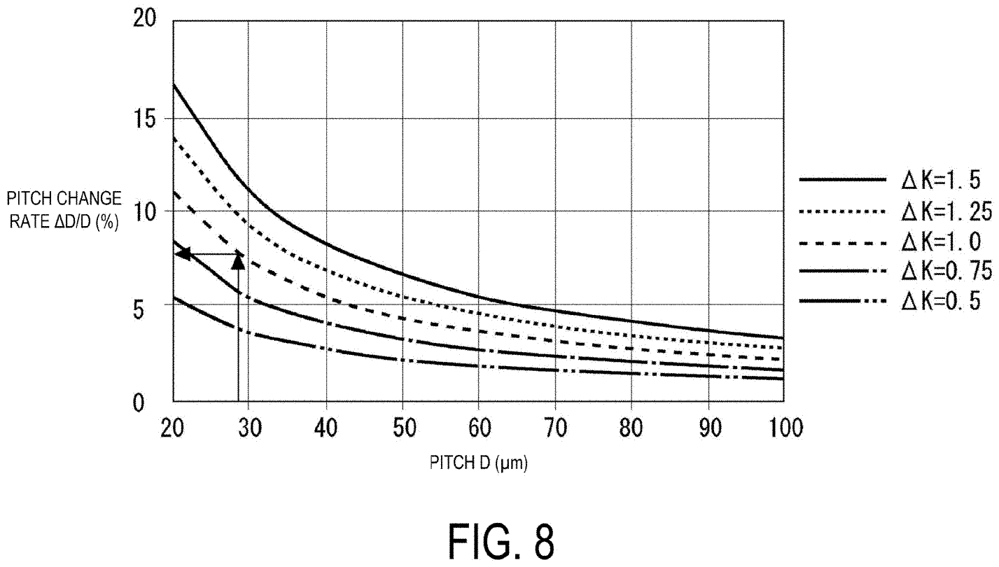

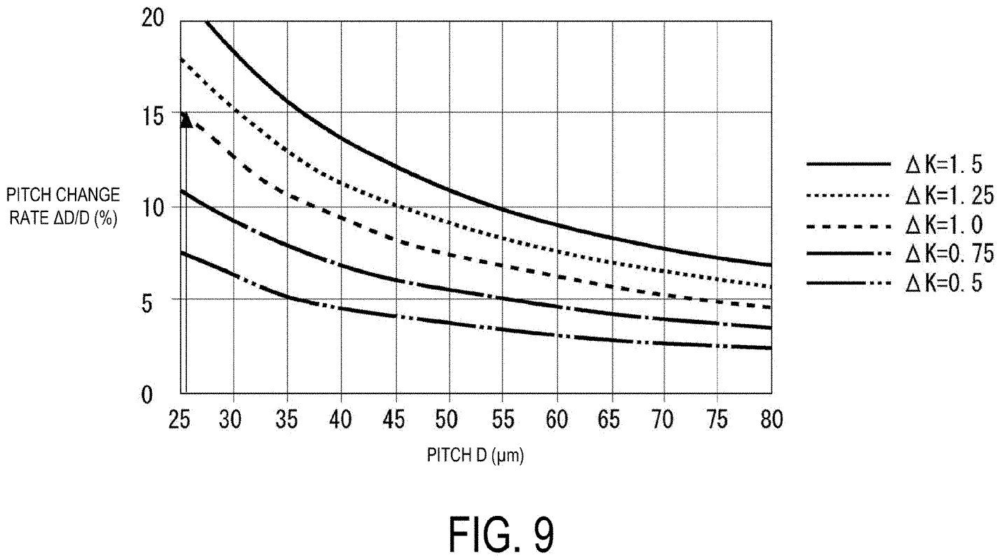

FIG. 7 illustrates the relationship between the emission light angle β (deg) and the change ΔD (μm) in pitch, with various ΔK. According to the relationship illustrated in FIG. 7, for example, when the emission light angle β is 25 deg, the change ΔD in pitch with which ΔK=1 holds is 2.2 μm. FIG. 8 illustrates the relationship between the pitch D and a pitch change rate ΔD/D, values of ΔK in a case where the emission light angle β is 25 deg. When the pitch D=28 μm holds, the pitch change rate ΔD/D with which ΔK=1 holds is approximately 7.5%. From the graph in FIG. 8, it can be seen that the range of the pitch change rate ΔD/D with which ΔK≤1 holds is ΔD/D≤11% with the pitch D in a typical range. FIG. 9 illustrates the relationship between the pitch D and the pitch change rate ΔD/D with values of ΔK in the case where the emission light angle β is 15 deg. It can be seen that a range of the pitch change rate ΔD/D with which ΔK≤1 holds is ΔD/D≤15%, with the pitch D being 25 μm or greater.

Thus, it is expected that the occurrence of interference fringes can be suppressed with the pitch D randomly varying in the following range of a change rate:

0≤ΔD/D≤15% (10).

Similarly, assuming that the emission light angle β is 10 deg or less, and the pitch D is 25 μm or greater, the pitch change rate ΔD/D with which ΔK≤1 holds is in a range of ΔD/D≤22%. Thus, it can be regarded that to cover various patterns of the pitch D, the emission light angle β, and the wavelength λ, the pitch D is randomly varied preferably in the following range of change rate:

0≤ΔD/D≤22% (10B).

Furthermore, there is a tradeoff relationship between an increase in the range of ΔD/D as the countermeasure for interference and the sharpness of the edges of an image obtained by irradiation light that has passed through the microlens array 1. In view of this, the range may be set to be differently according to the purposes. Specifically, the countermeasure for interference can be prioritized with the range set to 0≤ΔD/D≤22%, the quality of the image of the irradiation light can be prioritized with the range set to 0≤ΔD/D≤11%, and the balance between these can be prioritized with the range set to 0≤ΔD/D≤15%, for example.

Next, in the present example, the reason why the occurrence of interference fringes can be suppressed by randomly setting the optical path difference (phase difference) between the light beams B with ΔK being in a range of 0 to 1 will be described. In this context, the light can be expressed as a complex amplitude E as follows.

E=A·exp(−i(Kx−ωt)) (ii),

where A is the amplitude, K is the wavenumber, x is the position, ω is the angular frequency, t is the time, Kx is the advancement of the spatial phase, and ωt represents the advancement of the time phase.

An intensity I of the light is proportional to a product of E and a complex conjugate E* of E, and thus

I=|E|²=E·E*=A·exp(−i(Kx−ωt))×A·exp(i(Kx−ωt))=A² (12)

holds.

In this context, the following formulae are obtained for taking superimposition of a plurality of light beams into consideration:

E1=A1·exp(−i(K1x−ωt))

E2=A2·exp(−i(K2x−ωt))=A2·exp(−i(K1x−ωt+φ2))

E3=A3·exp(−i(K3x−ωt))=A3·exp(−i(K1x−ωt+φ3)) (13).

Formula (14) expresses an intensity Iₜₒₜₐₗ as a result of superimposing these:

Iₜₒₜₐₗ=|E1+E2+E3+ . . . |² . . . (14).

When the amplitudes of all the light beams are assumed to be the same and are defined as A, and an initial phase of E1 is defined as φ1 for convenience, the following formulae are obtained for the light beams superimposed as described above:

E1=A·exp(−i(K1x−ωt+φ1))

E2=A·exp(−i(K2x−ωt))=A·exp(−i(K1x−ωt+φ2))

E3=A·exp(−i(K3x−ωt))=A·exp(−i(K1x−ωt+φ3)) (15).

An intensity Iₜₒₜₐₗ as a result of superimposing these is as follows:

Iₜₒₜₐₗ=(E1+E2+E3+ . . . En)·(E1+E2+E3+ . . . En)*=(A·exp(−i(K1x−ωt+φ1))+A·exp(−i(K1x−ωt+φ2))+ . . . )·(A·exp(i(K1x−ωt+φ1))+A·exp(i(K1x−ωt+φ2))+ . . . ) (16).

Finally, it can be defined as in Formula (17) below:

$$[ Math . 3 ]$$

$${A}^{2} \cdot ( N + 2 {\sum }_{n = 1}^{N - 1} {\sum }_{m = n + 1}^{N} cos ( ϕ n - Φ m ) ) \qquad ( 17 )$$

According to Formula (17), all φn−φm being 2 nπ leads to the most constructive relationship between the light beams, resulting in Iₜₒₜₐₗ being (N·A)². Furthermore, φn−φm being random and leading to the destructive relationship results in the intensity being zero.

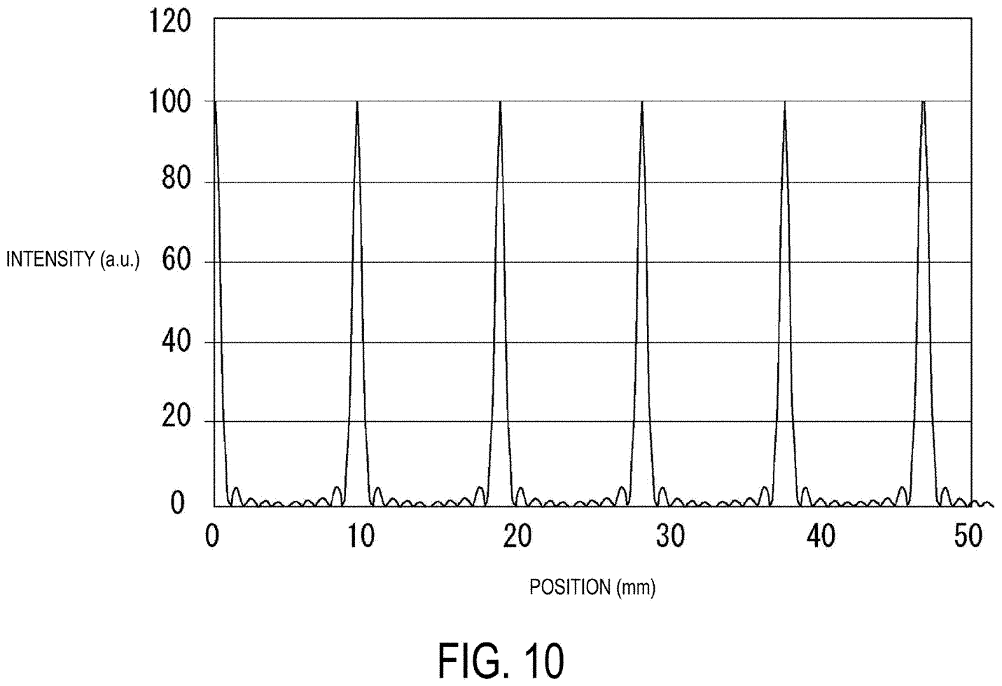

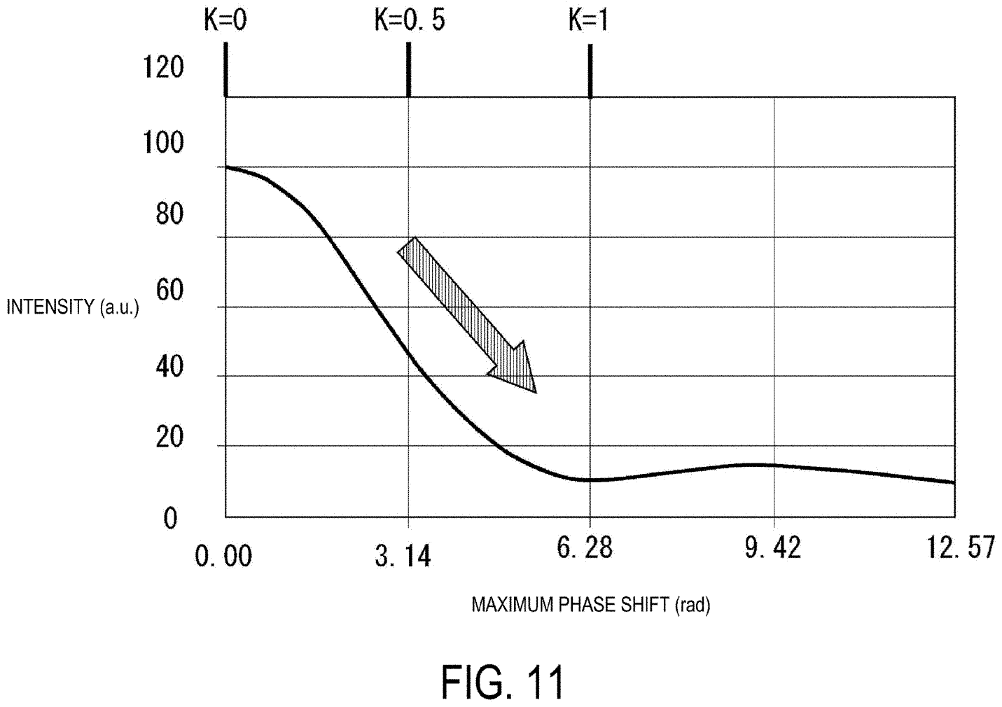

FIG. 10 illustrates a predicted value of the light intensity in a case where the number N of superimposed light beams is 10. It can be understood that with the multiple interferences as described above, noticeable constructive relationship between the light beams B is established at a certain position on the screen 3, and displacement from the peak of the intensity of the light beams B results in a sharp drop in the intensity of the light beams B. FIG. 11 is a graph illustrating a reduction in the intensity in peak portion with the constructive relationship in FIG. 10, due to random variation of the optical path difference (phase difference) between the light beams B with ΔK being in a range of 0 to 1.

It can be seen that when the number N of the superimposed light beams is 10, the peak intensity is reduced to about 1/10 due to the random variation of the optical path difference (phase difference) between the light beams B with ΔK being in a range of 0 to 1. Thus, the variation in intensity caused by the interference fringes can be substantially prevented, with the optical path difference (phase difference) between the light beams B randomly varied with ΔK being in a range of 0 to 1.

### Second Embodiment

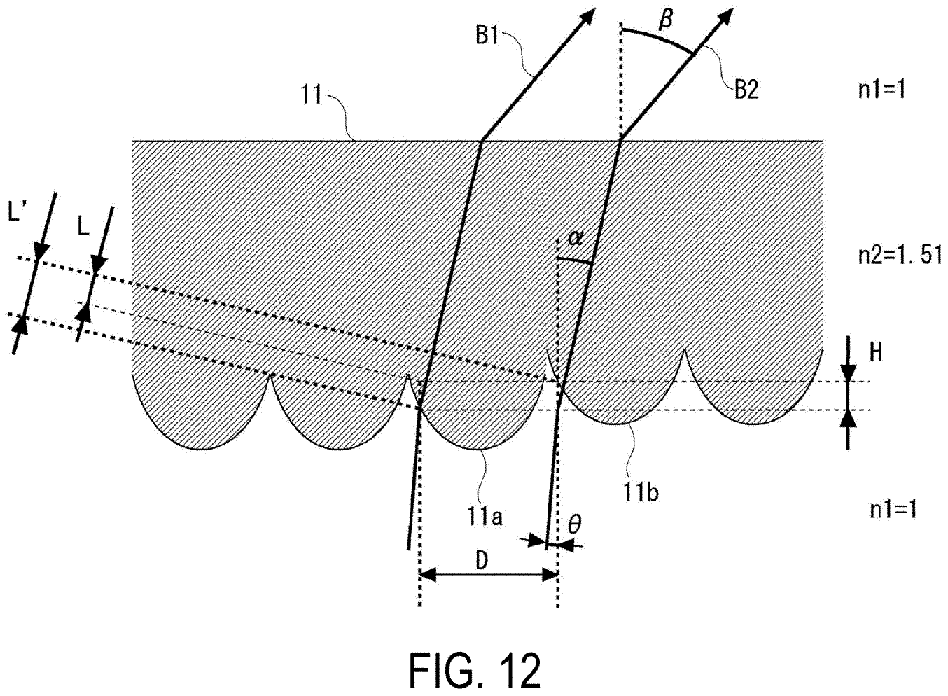

Next, a description is given on an example where the occurrence of the interference fringes is suppressed, with the heights of the lens elements randomly set in addition to the pitch D between the lens elements in the microlens array. FIG. 12 is an enlarged cross-sectional view of a microlens array 11. As illustrated in FIG. 12, the microlens array 11 is characterized by heights of the lens elements 11a and 11b, as well as the curved surface shape of each of lens elements 11a and 11b and the distance (pitch) D between the lens elements 11a and 11b. The lens elements 11a and 11b are the same in the curved surface shape and the pitch D. and are different from each other in the height only.

As illustrated in FIG. 12, a description will be given on two light beams B1 and B2 that are obliquely incident on the adjacent lens elements 11a and 11b. The light beams B1 and B2 are assumed to be incident on the same locations of the lens elements 11a and 11b adjacent to each other with different heights. In this case, the two light beams B1 and B2 travel in the microlens array 11 in a direction inclined by the propagation angle α with respect to the optical axis, in accordance with the angle of incidence on the lens elements 11a and 11b. Then, the light beams are further refracted at an emission surface that is a surface opposite to the incidence surface provided with the lens elements 11a and 11b, to travel in a direction inclined by the emission angle β with respect to the optical axis. In this case, Formula (18) below expresses an optical path difference L′ obtained by the pitch D between and a height H of the lens element 11a and the lens element 11b:

L′=n2×D·sin α+H·(n2/cos α−n1/cos θ) (18).

In the formula, θ represents the incident angle of the light beam B1 and the light beam B2 incident on the lens element 11a and the lens element 11b (angle with respect to the normal line of the incident light). Furthermore, in Formula (19) below, the light beam B1 and the light beam B2 are constructive when wavenumber K=N (integer) holds, and are destructive when the wavenumber K=0.5+N holds. Based on these relationships, the interference fringes are produced on the screen 3.

$${L}^{′} = n 2 \times D \cdot sin α + H \cdot ( n 2 / cos α - n 1 / cos θ ) = K \cdot λ . \qquad ( 19 )$$

Here, n2 represents the refractive index of the microlens array 11, and λ represents the wavelength of the incident light.

Formula (20) and Formula (21) below express a change amount ΔL of the optical path difference L′ and the wavenumber difference ΔK, in a case where there is a difference ΔH in height between the lens element 11a and the lens element 11b, in addition to the pitch change amount ΔD of the pitch D between the lens elements 11a and 11b randomly set:

ΔL=n2×ΔD·sin α+ΔH·(n2/cos α−n1/cos θ) (20), and

ΔL/λ=ΔK (21).

Also in this case, the constructive and the destructive relationship between the light beams B1 and B2 are weakened, with the pitch D and the height H randomly varied to make ΔK between the adjacent lens elements 11a and 11b vary in a range from 0 to 1.

Thus, the occurrence of the interference fringes can be suppressed, with the change ΔD in the pitch D and the change ΔH in the height H according to Formula (20) and Formula (21) set to satisfy Formula (22).

$$[ Math . 4 ]$$

$$o ≦ n 2 \times Δ D \cdot sin α + Δ H ( \frac{n 2}{cos α} - \frac{n 1}{cos θ} ) ≦ λ \qquad ( 22 )$$

Note that, since n2×sin α=n1×sin β holds based on Snell's law, the formula described above can be converted into:

$$[ Math . 5 ]$$

$$o ≦ n 1 \times Δ D \cdot sin β + Δ H ( \frac{n 2}{\sqrt{1 - {( \frac{n 1}{n 2} \cdot sin β )}^{2}}} - \frac{n 1}{cos θ} ) ≦ λ . \qquad ( 23 )$$

In the embodiment described above, the case has been described in which the light emitted from the light source 2 passes through the microlens array 1, 11 and then is projected on the screen 3. However, the microlens array 1, 11 can also be used such that the light emitted from the light source 2 is reflected on the microlens array 1 and then projected on the screen 3.

In the present embodiment, the case has been described in which the lens elements 1a, 11a on the microlens array 1, 11 are arrayed on one side that is a side close to the light source 2, but those may also be arrayed on one side that is an opposite side from the light source 2. Furthermore, the lens elements may be arrayed on both sides.

The lens elements 1a, 11a have a cross-sectional shape defined by the curved surface shapes discontinuously arranged, but they may also have a shape defined with curved surface shapes continuously connected via smooth curved lines.

Furthermore, regarding the material of the microlens array 1, 11 in the present embodiment, the substrate and the lens elements 1a, 11a may be formed by different materials, or may be integrally formed by the same material. When the substrate and the lens elements 1a, 11a are formed by different materials, one of the substrate and the lens elements 1a, 11a may be formed by a resin material, and the other one may be formed by a glass material. When the substrate and the lens elements 1a, 11a are integrally formed with the same material, the transmission efficiency can be improved due to the absence of a refractive index interface. Furthermore, such a configuration is free of peeling between the substrate and the lens elements 1a, 11a, and thus can achieve a high reliability. In this case, the microlens array 1, 11 may be formed by resin only, or may be formed by glass only.

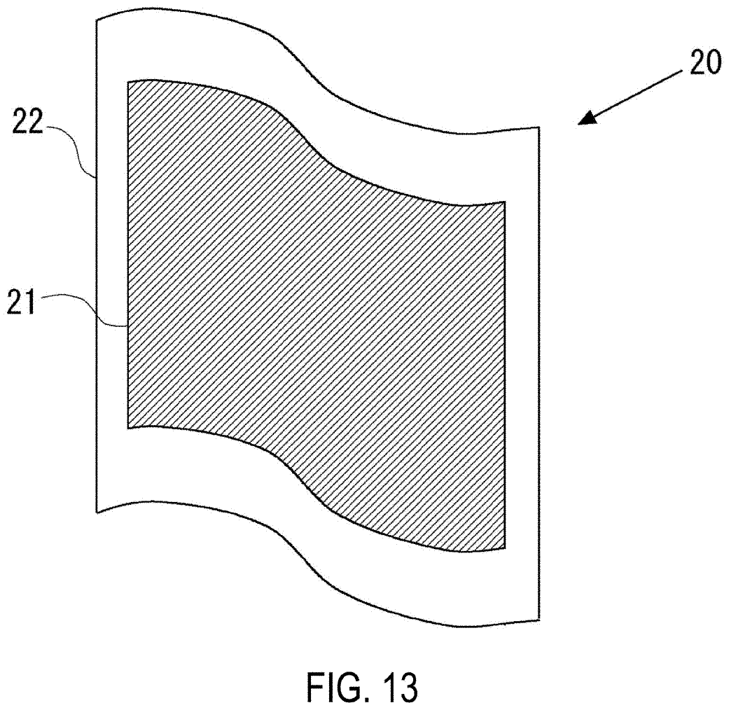

As illustrated in FIG. 13, a microlens array 21 having the same function as the microlens array 1, 11 described in the present embodiment may be formed on a flexible sheet 22, thereby forming a diffuser plate 20 that diffuses and uniformizes the incident light. It is obvious that the microlens array 21 can be formed on a rigid flat plate, to obtain a diffuser plate.

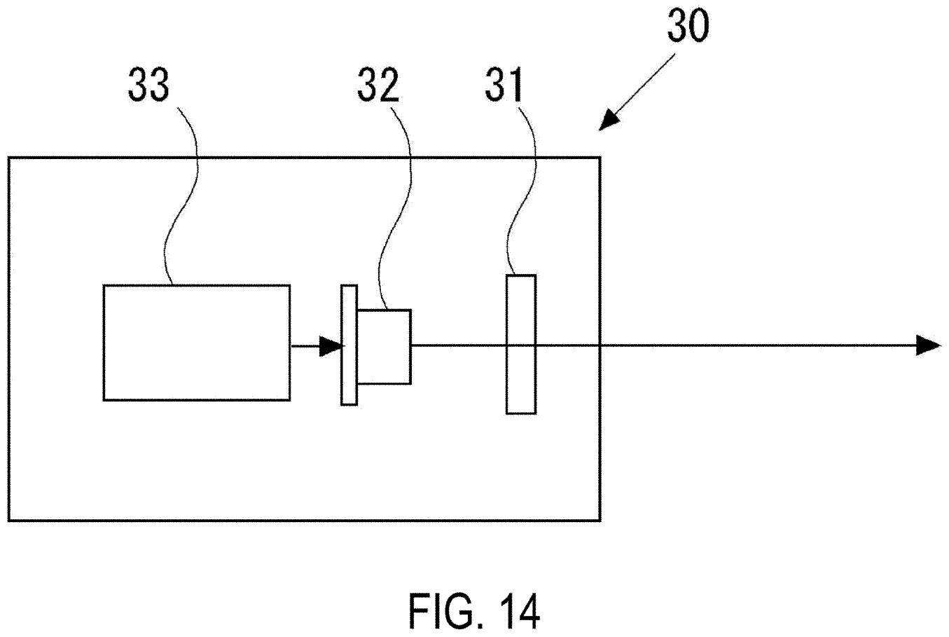

Furthermore, as illustrated in FIG. 14, a microlens array 31 having the same functions as the microlens array 1 described in the present embodiment, a light source 32, and a light source control unit 33 may be combined to form an illumination apparatus 30. The illumination apparatus 30 may be used alone for illumination, or may be incorporated into a measuring apparatus such as distance measuring equipment using the TOF system or other apparatuses. Also, in the illumination apparatus 30, the lens elements of the microlens array 31 may be arranged on one side that is on the light source 32 side, or may be arranged on one side that is an opposite side from the light source 32. The lens elements may be arranged on both sides. Furthermore, while the directivity of the light source 32 is not particularly limited, for example, the light source 32 with a directivity of ±20° or less may be used. More preferably, the light source 32 with a directivity of ±10° or less may be used. When the light source 32 with a high directivity is used, the irradiance distribution at both ends of the angle of view θ_{FOI} can be shaped to be more edgy.

Note that a microlens array having a function equivalent to that of the microlens array 1 described in the present embodiment may be used as an optical system for image capturing, face authentication in security equipment, or space authentication in vehicles or robots. Furthermore, the microlens array 1 described in the present embodiment may be used in combination with other optical elements including diffraction optical elements and refractive optical elements. Additionally, any coating may be applied to the surface of the microlens array 1.

### <Wiring of Conductive Substance>

Wiring including a conductive substance may be provided on the surface of or inside the microlens array 1, 11 according to the present embodiment, so that by monitoring the conductive state of the wiring, a damage on each lens elements 1a, 11a can be detected. With this configuration, a damage such as crack or peeling of each of the lens elements 1a, 11a can be easily detected. Thus, a problem caused by a failure and malfunctioning of an illumination apparatus or distance measuring equipment due to the damaging of the microlens array 1, 11 can be prevented in advance. For example, when the occurrence of a crack formed in the lens elements 1a, 11a is detected by disconnection of the conductive substance, emission of light from the light source may be stopped, so that 0th order light from the light source can be prevented from directly passing through the microlens array 1, 11 through the crack and being emitted to the outside. As a result, it is possible to improve the eye safety performance of the apparatus.

The wiring of the conductive substance described above can be provided around the microlens array 1, 11 or on each of the lens elements 1a, 11a. The wiring may also be provided on a surface on which the lens elements 1a, 11a are formed, a surface opposite to such a surface, or both surfaces. The electrically conductive substance is not particularly limited as long as it has electrical conductivity, and for example, a metal, a metal oxide, an electrically conductive polymer, an electrically conductive carbon-based substance, or the like can be used.

More specifically, the metal include gold, silver, copper, chromium, nickel, palladium, aluminum, iron, platinum, molybdenum, tungsten, zinc, lead, cobalt, titanium, zirconium, indium, rhodium, ruthenium, alloys thereof, and the like. Examples of the metal oxide include chromium oxide, nickel oxide, copper oxide, titanium oxide, zirconium oxide, indium oxide, aluminum oxide, zinc oxide, tin oxide, or composite oxides thereof such as composite oxides of indium oxide and tin oxide (ITO) and complex oxides of tin oxide and phosphorus oxide (PTO). Examples of the electrically conductive polymer include polyacetylene, polyaniline, polypyrrole, and polythiophene. Examples of the electrically conductive carbon-based substance include carbon black, SAF, ISAF, HAF, FEF, GPF, SRF, FT, MT, pyrolytic carbon, natural graphite, and artificial graphite. These electrically conductive substances can be used alone, or two or more types thereof can be used in combination.

The electrically conductive substance is preferably a metal or metal oxide having excellent electrical conductivity and easy to form a wire, and more preferably a metal. Gold, silver, copper, indium, or the like is preferred, and silver is preferred because it is mutually fused at a temperature of approximately 100° C. and can form a wire with excellent electrical conductivity even on the microlens array 1, 11 made of resin. A pattern and a shape of the wiring of the conductive substance is not particularly limited. A pattern surrounding the microlens array 1 may be used, or a pattern with a more complicated shape may be used for the sake of higher detectability for the crack or the like. A pattern covering at least part of the microlens array 1 by a permeable conductive substance may be used.

### CROSS-REFERENCE TO RELATED APPLICATION

This application is based upon and claims the benefit of priority of the prior Japanese Patent Application No. 2022-023094, filed on Feb. 17, 2022, the entire contents of which are incorporated herein by reference.

### REFERENCE SIGNS LIST

1, 11, 21, 31 Microlens array
1a, 11a, 11b Lens element
2 Light source
3 Screen
20 Diffuser plate
22 Flexible sheet
30 Illumination apparatus
32 Light source
33 Light source control unit
100 TOF distance measuring equipment
101 Light source control unit
102 Light source
103 Irradiation optical system
104 Reflection optical system
105 Light receiving element
106 Signal processing circuit

What is claimed is:

1. A microlens array comprising a plurality of lens elements arrayed on at least one surface of a planar member, wherein
a pitch D between the plurality of lens elements in the microlens array randomly varies in a range of ±ΔD, and
the ΔD satisfies
0≤ΔD≤λ/(n1×sin β),
where λ represents a wavelength of incident light, n1 represents a refractive index in air, and β represents an emission angle of light that has passed through the microlens array, the emission angle being an angle with respect to an optical axis.

2. The microlens array according to claim 1 formed integrally of a same material.

3. The microlens array according to claim 1 comprising wiring including a conductive substance.

4. The microlens array according to claim 3, wherein the wiring is formed on surfaces of the plurality of lens elements or around the plurality of lens elements.

5. A diffuser plate using the microlens array according to claim 1.

6. An illumination apparatus comprising:
the microlens array according to claim 1; and
a light source configured to emit light incident on the microlens array.

7. A microlens array comprising a plurality of lens elements arrayed on at least one surface of a planar member, wherein
a pitch D between the plurality of lens elements in the microlens array randomly varies in a range of ±ΔD, and
the D and the ΔD satisfy
0≤ΔD/D≤22%.

8. The microlens array according to claim 7 formed integrally of a same material.

9. The microlens array according to claim 7 comprising wiring including a conductive substance.

10. The microlens array according to claim 9, wherein the wiring is formed on surfaces of the plurality of lens elements or around the plurality of lens elements.

11. A diffuser plate using the microlens array according to claim 7.

12. An illumination apparatus comprising:
the microlens array according to claim 7; and
a light source configured to emit light incident on the microlens array.

13. A microlens array comprising a plurality of lens elements arrayed on at least one surface of a planar member, wherein
a pitch D between the plurality of lens elements in the microlens array randomly varies in a range of ±ΔD, and a height H of the plurality of lens elements varies in a range of ΔH, and
the ΔD and the ΔH satisfy,
$$[ Math . 1 ]$$
$$o ≦ n 1 \times Δ D \cdot sin β + Δ H ( \frac{n 2}{\sqrt{1 - {( \frac{n 1}{n 2} \cdot sin β )}^{2}}} - \frac{n 1}{cos θ} ) ≦ λ .$$
where λ represents a wavelength of incident light, n1 represents a refractive index in air, n2 represents a refractive index of the microlens array, θ represents an angle of light incident on each of the lens elements of the microlens array with respect to an optical axis, α represents a propagation angle of the incident light in the microlens array with respect to a normal direction and β represents an emission angle of light that has passed through the microlens array, the emission angle being an angle with respect to an optical axis.

14. The microlens array according to claim 13 formed integrally of a same material.

15. The microlens array according to claim 13 comprising wiring including a conductive substance.

16. The microlens array according to claim 15, wherein the wiring is formed on surfaces of the plurality of lens elements or around the plurality of lens elements.

17. A diffuser plate using the microlens array according to claim 13.

18. An illumination apparatus comprising:
the microlens array according to claim 13; and
a light source configured to emit light incident on the microlens array.
